(19) United States
(12) Patent Application Publication
(10) Pub. No.: US 2010/0263515 A1
(43) Pub. Date: Oct. 21, 2010

(54) Plectrum with attached grasping devices

(76) Inventor: James Theodore Hollin, JR., Throne, GA (US)

Correspondence Address: J.T. HOLLIN, ATTORNEY AT LAW, PC, 110 HABERSHAM DRIVE, SUITE 144, FAYETTEVILLE, GA, 30214, US

(21) Appl. No.: 12/660,984

(22) Filed: Mar. 9, 2010

Related U.S. Application Data
(63) Continuation-in-part of application No. 12/075,544, filed on Mar. 12, 2008, now abandoned.

(51) Int. Cl. G10D 3/16

(52) U.S. Cl. 84/322

(57) ABSTRACT

A device for playing a stringed musical instrument, comprising a tabbed plectrum with an enhanced feature, consisting of an extended gripping surface, or tab, which allows the attachment of a variety of grasping devices to the plectrum. Thusly, a musician is provided a secure and comfortable method for holding the plectrum while playing a stringed musical instrument. Both the plectrum and the grasping devices are used in conjunction with each other to facilitate the ergonomic playing of such instruments. Additionally disclosed is a method for the efficient movement of a musician's forearm and wrist muscles while playing a stringed instrument with the tabbed plectrum with any of the grasping devices.

### CROSS-REFERENCES TO RELATED APPLICATIONS

This application is a Continuation-in-Part application and claims priority and the benefits from U.S. utility patent application No. 12/075,544 filed on Mar. 12, 2008, as fully and completely as though said application appeared herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concepts presented herein generally are concerned with devices and methods for playing stringed musical instruments, especially guitars. Historically, stringed instruments such as guitars, bass guitars, banjos, mandolins and the like are played either with the fingers, or more frequently, with the assistance of a plectrum. Plectrums come in a variety of sizes, weights, densities, materials, and textures. They are usually 0.5 mm to 1.0 mm thick, but can be much thicker. Plectrums are generally constructed in the approximate shape of an isosceles triangle, with rounded base angles and a relatively elliptical apex, or “picking point.” The musician normally orients the plectrum so as to make the picking point the part of the plectrum which strikes the strings of the instrument. Occasionally a musician will orient the plectrum sidewise so as to strike the strings with one of the two sides of the plectrum and thus obtain a “fatter” sound from the strings.

It is not uncommon for a musician to lose the most effective position of his or her grip on the plectrum while playing, or to drop the plectrum entirely when playing rapid or intense passages consisting of multitudes of musical notes. If the grip on the plectrum is accidentally misaligned, the musician may not be able to timely strike the string or strings which for which he or she is aiming, and as an added consequence, the timbre of the string, or the quality of its induced resonance is lessened by such a mis-strike.

(2) Description of the Related Art

Musicians and instrument makers have been, for over one hundred years, making improvements and modifications in the basic simple plectrum, to make the device more versatile or convenient to use. A very early invention in this vein was designed in 1896, and involved a holder device for mandolin picks; ref. U.S. Pat. No. 557,293. The holder was flexible enough such that, by varying pressure on the device with the thumb and forefinger, a musician was able to strike the mandolin strings very soft with low volume or with force for louder, more emphatic tones. The holder minimized the risk of dropping the pick or losing grip.

In 1916, U.S. Pat. No. 1,184,561 presented a design for a mandolin pick holder which resembled a miniature horseshoe. The device was made with a recessed chamber, sized so as to accommodate the insertion of the pick. The preferred embodiment of the device was made of rubber, which gave enhanced gripping qualities to the musician, as the gripping pressure of the fingers engaged the friction of the rubber. The pressure of the fingers also provided a firm retention force for maintaining the pick inside the horseshoe-shaped receptacle.

U.S. Pat. No. 1,263,740 features a pick for stringed instruments which is constructed with a small hole or aperture at the gripping end of the pick. A thin wire is inserted through the hole and then looped on both sides of the pick. The double loops provide resting places, or anchors, for the two most conveniently located fingers involved in gripping the pick for playing.

U.S. Pat. No. 2,776,592 describes a guitar pick attachment designed with a ring-like mechanism to fit over the forefinger. This helps prevent accidental dropping of the pick. The ring-like mechanism is connected to the pick by a “tongue” that is an integral part of the pick. The pick may be swiveled around its position on the ring-like mechanism to a non-playing position, which allows freedom of the fingers to pluck the instrument.

U.S. Pat. No. 3,699,838 consists of a guitar pick manufactured with an integral, continuous circular band extending from both sides of the pick. The band is designed with sufficient tension so as to securely hold a thumb or finger as that digit is inserted within the circular band in preparation for gripping the pick.

A relatively intricate pick design is disclosed in U.S. Pat. 4,270,433, which claims a plectrum ring. The ring element is designed to be worn about the middle finger of the musician's playing hand, with the plectrum being snapped into place by means of a stud and boss assembly on the surface of the ring element. The plectrum may have one or more boreholes drilled into it to allow a selection of multiple positions and angles for the plectrum to be attached to the ring element. Other variations of this basic mechanism are further disclosed.

U.S. Pat. No. 4,497,237 consists of a guitar pick with two curved metallic bands attached to the pick. The pick itself has two small pads, one glued to each side of the gripping half of the pick. There are grooves within the pads to allow the insertion of the two bands. The bands are relatively stiff but deformable to allow insertion of the musician's fingers and also to allow the pick to be swiveled out of playing range when the pick is not in use.

U.S. Pat. No. 5,837,913 features a plectrum which is attached to a flexible tongue device, which in turn is connected to a bendable, circular hand engaging member. The hand engaging member is designed to be variably fitted onto the base of the musician's middle finger. Thereafter, the flexible tongue stretches to allow the pick to be grasped by the musician's thumb and forefinger for playing the instrument.

An abandoned British patent application (publication #GB2347550) discloses a variety of plectrum devices, including one with a handle to be grasped in the user's fist. At least one variety of the handle is manufactured with a tongue-like device which is integral to the handle and extends outward an appropriate distance so as to allow the attachment of a pick to the tongue.

Another development with respect to playing stringed instruments is a device referred to as the F-1™ “Ergonomic Guitar Pick.” This invention is described in U.S. Pat. No. 6,054,643 and is designed to be used as either a pick or a pick holder. It resembles an inverted clamshell, and features a pick of engineered material with a curved finger grip. One side of the device is a finger cradle, or saddle, to accommodate either the thumb or the index finger of the musician. The opposite side of the device is a flat planar area for ease of gripping with pressure exerted by the other fingers.

### BRIEF SUMMARY OF THE INVENTION

The inventive concepts herein disclose a re-designed plectrum, sometimes commonly referred to as a “guitar pick,” suitable for playing a stringed musical instrument. The disclosed plectrum features an improvement comprising an extended gripping surface, or “tab,” which allows the attachment of a variety of grasping devices, or “tethers” to the plectrum. The tab, along with the tether, provide a stringed instrument player, (referred to as the “musician” herein) more comfort, more reliable gripping pressure, and a greater consciousness of ergonomically correct muscular movements when playing a stringed musical instrument. The combination of the tab and tether allows a musician to more effectively hold the plectrum and to apply more accurate placement when the plectrum strikes the strings of the instrument.

### BRIEF DESCRIPTION OF THE VIEWS OF THE DRAWINGS

The objects, features, and advantages of the concepts presented in this application are more readily understood when referring to the accompanying drawings. The drawings, totaling twelve figures, show the basic functioning of the tabbed plectrum, combined with various types of tethers. In the several figures, like reference numbers are used in each figure to correspond to the same component as may be depicted in other figures.

FIG. 1 depicts a common plectrum, or “pick” which has been enhanced by the construction of an extended gripping end, referred to as a “tab.”

FIG. 1(a) shows the tabbed plectrum having an aperture excised from the tab, perpendicular to the base of the plectrum.

FIG. 2 presents a view of the tabbed plectrum in which the hook component of a hook-and-felt fastening mechanism has been attached to the tab.

FIG. 3 illustrates the tabbed plectrum with an aperture excised parallel to the base of the plectrum, said aperture allowing a means of attaching various grasping devices to the plectrum.

FIG. 4 depicts a full-length view of a straight-line tether (“SLT”). As shown, each end of the SLT is flared into a wedge shape and the wedge portion is also constructed with an adhesively-attached felt component of a hook-and-felt fastening mechanism.

FIG. 5 shows a variably-looped tether (“VLT”). The VLT is specifically designed to provide both a means of attaching the VLT to a tabbed plectrum and a means of attaching the VLT to itself, as comfortable.

FIG. 6 presents a view of a Double-Folding Tether (“DFT”). A portion of each end of this grasping device is constructed with the hook component of a hook-and-felt fastening mechanism, while the center portion comprises the felt component.

FIG. 6(a) illustrates one end of the DFT in the process of being attached to a bottom-slotted plectrum with the opposite end of the DFT secured by a retaining clamp.

FIG. 7 presents a cross-sectional view of an adjustable retaining clamp which may be used in conjunction with either the SLT or the DFT. The retaining clamp is used to adjust the length of either device so as to comfortably fit within the grasp of the playing hand of the musician and to provide playing leverage against the tab.

FIG. 8 is a drawing illustrating the proper method of grasping a bottom-slotted plectrum and the manner of holding an SLT lightly within the grasp of the instrument player's hand. Also depicted are vectors representing ergonomic wrist and forearm orientation and movement to strike one of the strings of a musical instrument.

FIG. 9 illustrates the variably-looped tether (VLT) as it is inserted into a bottom-slotted plectrum.

FIG. 10 shows the VLT having been inserted through the aperture of a slide-slotted plectrum.

FIG. 11 depicts an alternative embodiment of the DFT, with the addition of a flexible medium connecting the two fastening ends of the grasping device.

FIG. 12 presents another view of the DFT, showing the orientation of the hook and felt components of the fastening mechanism.

### NOMENCLATURE FOR INVENTION COMPONENTS

1. Tabbed plectrum
2. Apex of plectrum
3. Tab
4. Hook component of fastening mechanism
5. Velcro-enhanced plectrum
6. Aperture
7. Side-slotted plectrum
8. Felt component for fastening
9. Straight-line tether; SLT
10. Wedge
11. Variably-looped tether; VLT
12. Double-folded tether; DFT
13. Retaining clamp
14. Bottom-slotted plectrum
15. Flexible medium
16. Extendable-length tether; ELT
17. Base of plectrum
18.-19. Not applicable
20. Centerline between apex and aperture
21. Forearm static vector
22. Rotational arc of forearm
23. Rotational arc of wrist (a) upward; (b) downward
24. Distal joint of index finger
25. Proximal joint of index finger
26. Inner wrist bone
27. Guitar string
28. Strumming axis
29. not applicable
30. not applicable
31. Spring in retaining clamp
32. Body of retaining clamp
33. Inlet opening
34. Piston
35. Chamber
36. Outlet opening

### DETAILED DESCRIPTION OF THE INVENTIVE CONCEPTS

### Plectrum Designs

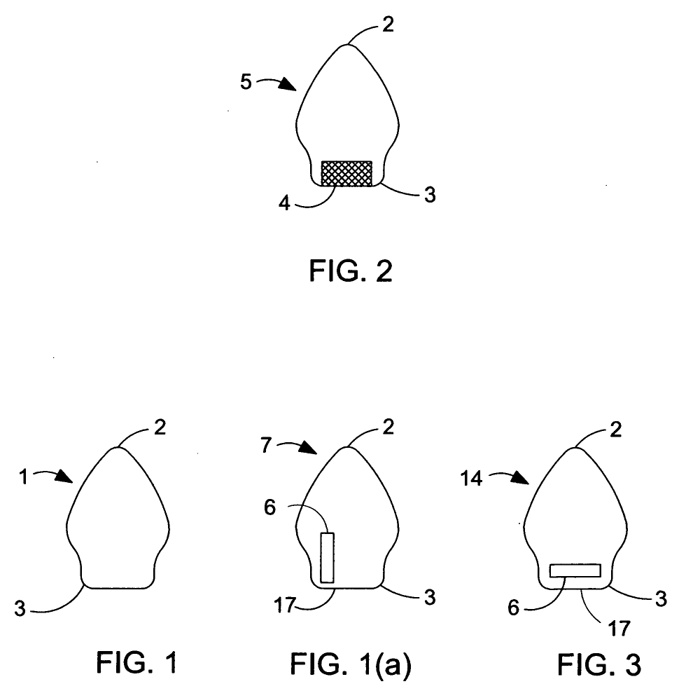

FIG. 1 presents an enhanced design of a “traditional” plectrum, resulting in a “tabbed” plectrum 1. As shown, the tabbed plectrum 1 resembles the standard contour of the vast majority of plectrums commonly used. The tabbed plectrum 1 is held by its flat surfaces and normally grasped between the musician's thumb and index finger. An elliptically-shaped apex 2 is the plectrum surface point, or “picking point” at which the tabbed plectrum 1 normally makes contact with the strings of the musical instrument. It is observed that the tabbed plectrum 1 is fabricated with an extended, or protruding gripping surface, referred to as a “tab” 3. The tab 3 serves (a) as a means of facilitating the attachment a plurality of hand-held grasping devices to the tabbed plectrum 1, (b) to increase the gripping surface of the tabbed plectrum 1, and (c) to increase the leverage of the tabbed plectrum 1 as it strikes the strings of a musical instrument.

FIG. 1(a) presents a side-slotted plectrum 7, which features a slot 6 excised from the tab 3, perpendicular to the base 17 of the side-slotted plectrum 7. The perpendicular orientation of the slot 6 allows the attachment of any of the grasping devices presented in the disclosure herein.

FIG. 2 presents an embodiment of the tabbed plectrum 1 comprising the attachment of the hook component 4 of a hook-and-felt fastening mechanism to the tab 3, resulting in an adhesively-enhanced plectrum 5. This hook component 4 of a hook-and-felt fastening mechanism allows the attachment of a plectrum to the appropriate segment of a plurality of grasping devices, said devices so constructed with the corresponding felt component 8 of the hook-and-felt fastening mechanism.

In FIG. 3, a bottom-slotted plectrum 14 is shown with an aperture 6 excised parallel to the base 17 of the bottom-slotted plectrum 14. The aperture 6 serves as a means of attaching a variety of custom-made grasping devices to the bottom-slotted plectrum 14. By using custom-made grasping devices, said devices so designed with strap-like contours, one end of any of these several devices can be inserted into the aperture 6 and, by various means, secured to, or by, the playing hand of the musician.

The primary objective of the various plectrum designs is to allow multiple means by which to attach a grasping device, particularly a tether, to the plectrum. Thereby, a stringed musical instrument (particularly, guitar) may be played with a plectrum that has enhanced and versatile gripping qualities. By utilizing the various grasping devices which are disclosed in the following paragraphs, a musician is aided in minimizing minimize muscle strain and other repetitive use injuries often associated with frequent playing a stringed musical instrument. The combined use of the enhanced plectrums and grasping devices will also help generate a more solid, accurate, and confident striking of the strings

### Grasping Devices, or “Tethers”

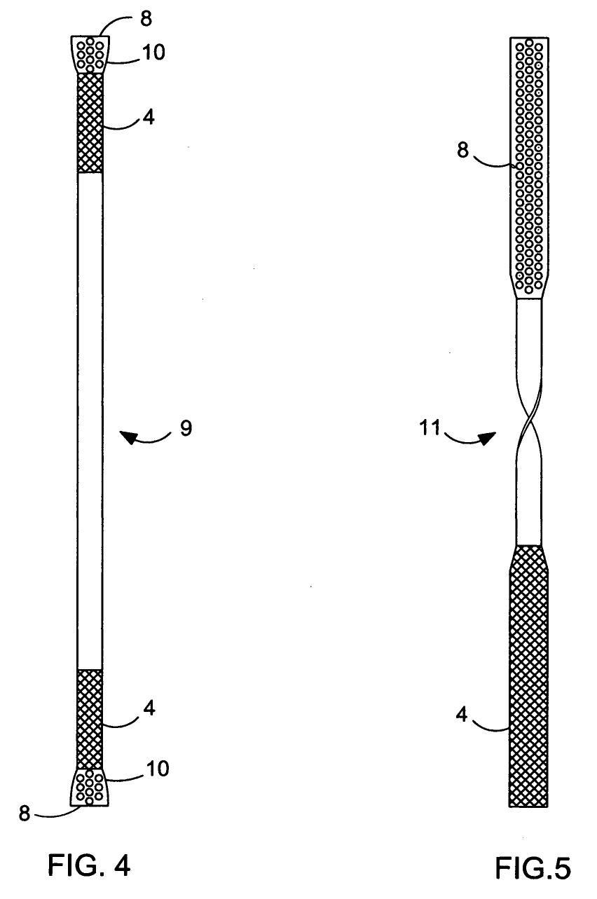

FIG. 4 illustrates a basic grasping device, referred to as the Straight-Line Tether (SLT) 9. This device is designed to function with any of the tabbed plectrums disclosed herein. The SLT 9 has a contour similar to that of a miniature strap or belt and is symmetrically designed. At each end of the SLT 9 is a flared section, or wedge 10. The dimensions and overall area of the wedge 10 correspond to the approximate dimensions and surface area of the hook component 4 of the velcro-enhanced plectrum 5 shown in FIG. 2. Further, both sides of this flared section of the wedge 10 comprise the felt component 8 of a hook-and-felt fastening mechanism. Therefore, the wedge 10 can be easily fastened to the velcro-enhanced plectrum 5 by positioning either side of the wedge 10 onto the hook component 4 and applying slight pressure.

The SLT 9 is of sufficient length so as to fit comfortably in the grasp of a musician's strumming, or plucking hand, i.e., the hand that is predominantly used for striking the strings of the musical instrument. Immediately adjacent to the wedge 10 area of the SLT 9 is a brief section comprising the hook component 4 of a hook-and-felt attaching mechanism. By this arrangement, the end of the SLT 9 which is not attached to a plectrum may also be utilized to hold a spare, or a different weight plectrum, simply by inserting the unattached end through the spare plectrum aperture 6 and re-attaching to the hook component of the SLT 9. Additionally, as will be shown later, the musician may attach a retaining device to the non-playing end of the SLT 9.

In referring to FIG. 5, the illustration depicts a device designated as a Variably-Looped Tether (VLT) 11. A full-length view of one side of the VLT 11 is presented. Approximately one-third of one endmost section of the length of the VLT 11 is comprised of the felt component 8 of a hook-and-felt fastening mechanism, while the opposite endmost section is comprised of the same length of the hook component 4 of a hook-and-felt fastening mechanism.

The VLT 11 is constructed such that either end of the device may be inserted through the aperture 6 of the side-slotted plectrum 7 or the bottom-slotted plectrum 14, looped around the musician's playing hand or fingers, and thereupon pressed against the opposite end with sufficient pressure to initiate fastening.

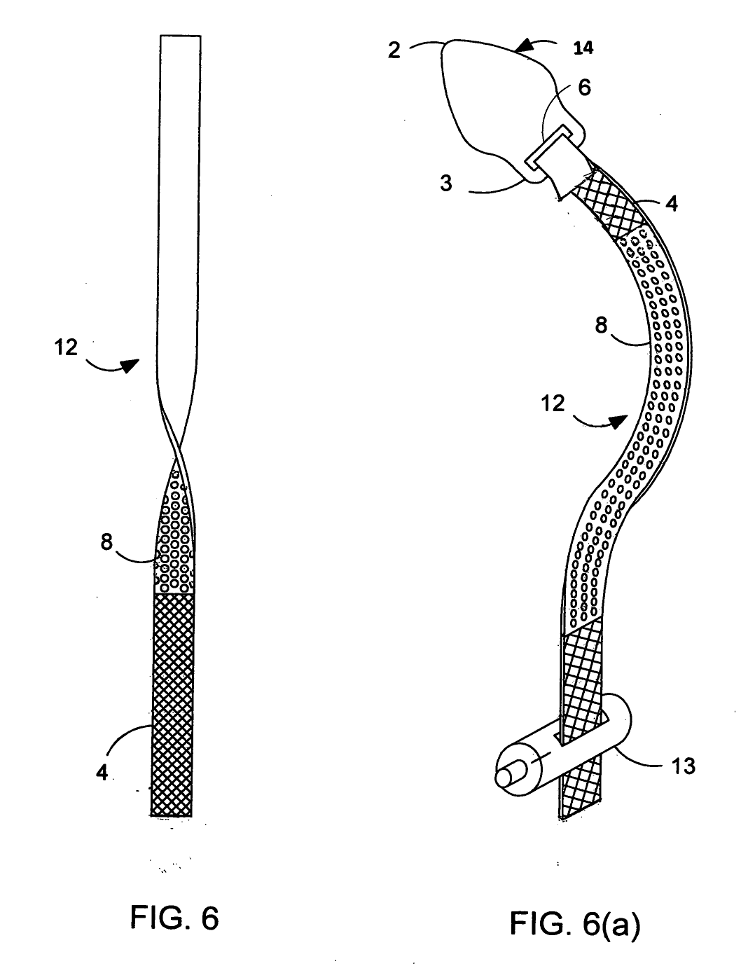

FIG. 6 depicts a grasping device entitled a Double-Folding Tether (DFT) 12. One side of the DLT 12 is comprised of two segments of the hook component 4 of a hook-and-felt fastening mechanism forming a segment of each end of the DLT 12, and the remaining center segment of the DLT 12 is comprised of the felt component 8 of the hook-and-felt fastening mechanism. The reverse side of the DFT 12 is devoid of either the hook or the felt component of the hook and felt fastening mechanism.

FIG. 6(a) illustrates the operating mode of the DFT 12, which is designed to function with either the bottom-slotted plectrum 7, shown in FIG. 3, or with the side-slotted plectrum 14. As shown in FIG. 6(a), one end of the DFT 12, comprising the hook component 4 of a hook-and-felt mechanism, is inserted into the aperture 6 of the bottom-slotted plectrum 14 a sufficient distance so as to permit the inserted end to be folded back onto the section of felt component 8 of the DFT 12. In this manner, the DFT 12 is securely attached to the bottom-slotted plectrum 14.

The opposite end of the DFT 12 may be inserted into a retaining clamp 13 a sufficient distance so as to be folded back onto the felt component 8 of the DFT 12, thus holding the retaining clamp 13 at the end of the DFT 12. The retaining clamp 13 shown is a common version of a spring-loaded toggle clip used extensively in various types of clothing attire.

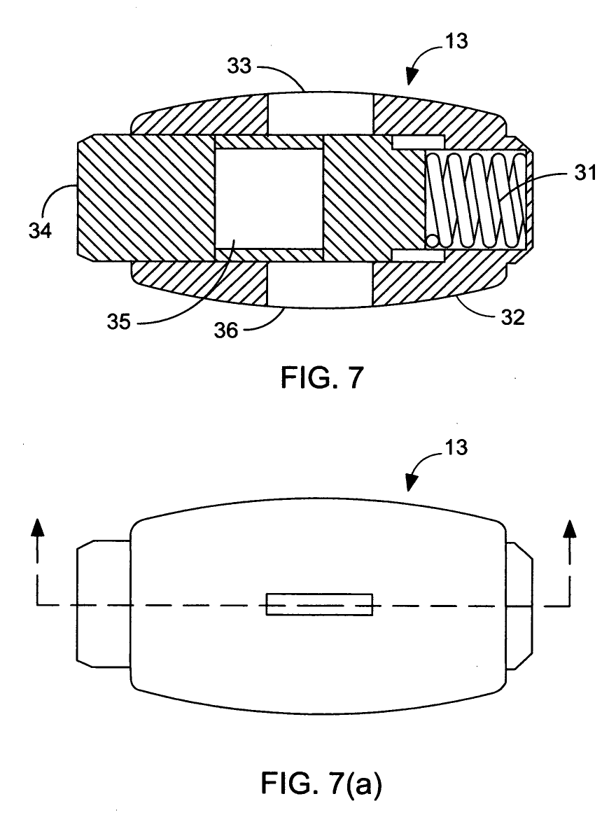

FIG. 7 presents the cross-sectional details of a typical retaining clamp 13, which, as an example, may be used in conjunction with the DFT 12. In operation, the musician grasps the body 32 of the retaining mechanism 13, while simultaneously pushing the retaining mechanism's piston 34 from left to right against the resistance of a spring 31. The pushing force exerted causes a chamber 35 to slide into alignment with an inlet opening 33 and an outlet opening 36. One end of the DFT 12 is then inserted through the inlet opening 33, the chamber 35, and the outlet opening 36, in sequence. The pressure on the piston 34 is then released, causing the DFT 12 to be securely clamped between the interior of the body 32 and the outer wall of the piston 34.

The musician may further bend the inserted end of the DFT 12 around the retaining clamp 13 and attach the end to the felt component 8 of the DFT. If it becomes necessary to adjust the length of the DFT 12, as shown in FIG. 6(a), the musician must push on the piston 34, thereby releasing the grip of the retaining clamp 13, and permitting the DFT 12 to slide freely through the chamber 35 in either direction.

Again, referring to FIG. 6(a), by grasping the bottom-slotted plectrum 14 in preparation for playing a stringed musical instrument, the musician should allow the length of the DFT 12, while attached to the retaining clamp 13, to hang freely within the grasp of the curled fingers of the strumming hand. The musician may then establish an effective and comfortable playing position using proper hand and wrist orientation. After making the necessary length-wise adjustment to the DFT 12, the retaining clamp 13 may, if desired, rest snugly against the outer portion of the little finger while playing.

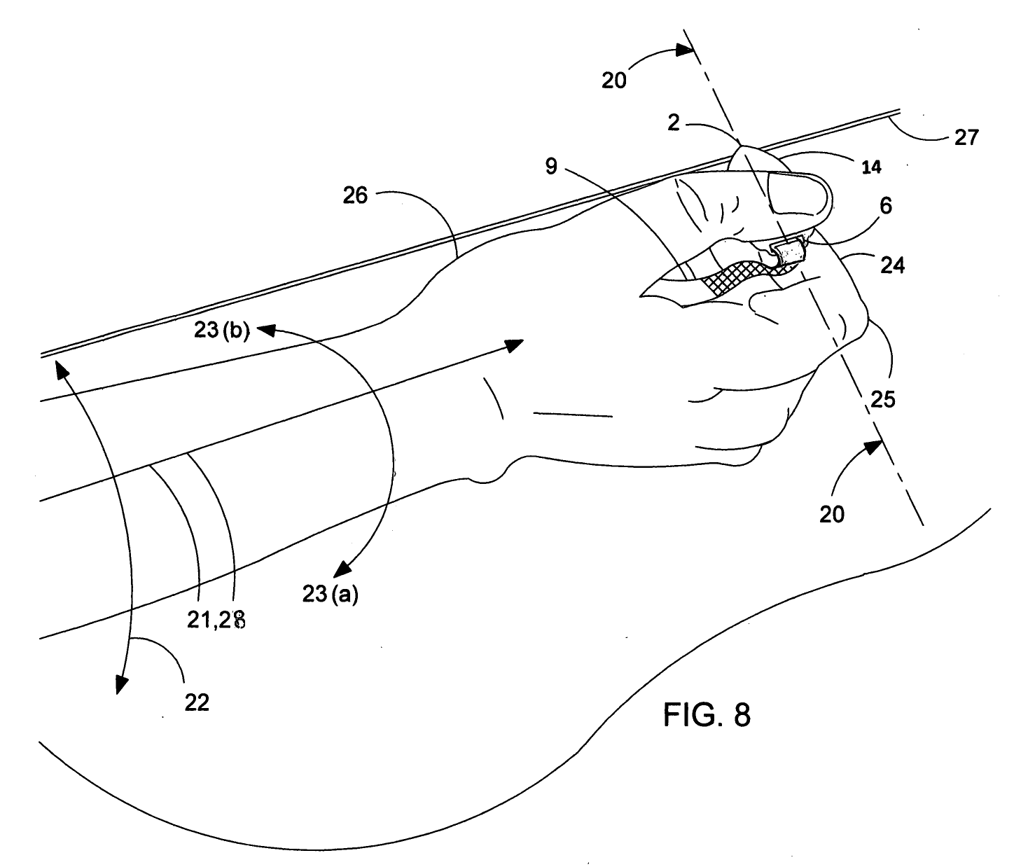

Next, attention is turned to FIG. 8, depicting a musician's hand holding a bottom-slotted plectrum 14 and simultaneously allowing the hand to loosely grasp a Straight-Line Tether (SLT) 9. For simplicity of explanation, only one string 27 of a guitar is shown.

FIG. 8 demonstrates the preferred manner of grasping a bottom-slotted plectrum 14 when utilizing the SLT 9. The flat surfaces of the bottom-slotted plectrum 14 are “sandwiched” between the thumbprint and the outside portion of the index finger, directly on top of the index finger's distal joint 24. The SLT 9 can be observed suspended lightly within the curl of the musician's fingers. Ideally, when the bottom-slotted plectrum 14 is held ergonomically correct, a centerline 20 drawn between the apex 2 of the bottom-slotted plectrum 14 and the aperture 6 should overlay and parallel a line connecting the distal joint 24 and proximal joint 25 of the index finger. Thus oriented, the bottom-slotted plectrum 14 can be brought into close proximity with the string 27 of the musical instrument and the bottom-slotted plectrum 14 is easily directed to make forceful, or light, contact with any of the strings. One must also keep in mind that the dynamics of orienting the musician's hand and fingers, as described in this paragraph, apply with equal meaning to any combination of the tabbed plectrums and grasping devices disclosed herein.

FIG. 8 further serves to illustrate the preferred method of manipulating the musician's hand, wrist 26, and forearm muscles 22, while playing a stringed musical instrument, such as guitar, banjo, mandolin, or other similarly designed instrument. For illustrative purposes only, the aperture 6 is made visible in FIG. 8. However, during actual instrument playing conditions, the aperture 6 may be covered by the inner edge of the thumb. In FIG. 8, a pointed straight line, referred to as the “forearm static vector” 21, represents an imaginary line between the aperture 6 of the bottom-slotted plectrum 14, the inner wrist bone 26, and the elbow (which is out of view in this Figure). The same forearm static vector 21 also overlays another important vector concept in this invention, the “strumming axis” 28. If the forearm static vector 21 were extended toward the musician's hand, and if the aperture 6 of the bottom-slotted plectrum 14 could be viewed while looking through the thumbnail, the aperture 6 would lie directly over the extended strumming axis 28.

To initiate the ergonomic striking of the string 27 for a single “pluck,” the musician must rotate the inner wrist bone 26 in the direction shown in FIG. 8 by the downward wrist rotational vector 23(b), which causes the firmly-held plectrum 7 to strike the string 27 with downward force (downstroke) and consequentially cause the string 27 to vibrate in the appropriate pitch. After the downward pluck of the string 27, the plectrum 7 is then in position to initiate an “upstroke” against the string 27. This is done by merely allowing the forearm muscle 22 to command a rotation of the inner wrist bone 26 in the direction shown by the upward wrist rotational vector 23(a), causing the plectrum 7 to contact the string 27 from underneath, again resulting in vibration of the string 27 at the appropriate musical pitch. It is important to maintain the wrist 26 and forearm 22 aligned with the strumming axis 28.

For continuous vibrato-type striking movements against the string 27, the musician need only recruit the forearm muscle 22 to rotate the wrist 26 back and forth as rapidly as desired, alternating the inner wrist bone 26 rotation in the directions shown by the rotational vectors, 23(a) and 23(b). The musician's elbow may need to change its angle slightly relative to the upper arm (humerus bone) in order to maintain the orientation of the static forearm static vector 21. The muscle movements herein described serve to minimize muscular fatigue, Repetitive Strain Injury (RSI), carpal tunnel syndrome, and varied forms of “tennis elbow”—type injuries. These ailments are often suffered by guitarists who practice and/or play engagements regularly and for long sessions, without conscious effort to efficiently coordinate their arm muscle groupings.

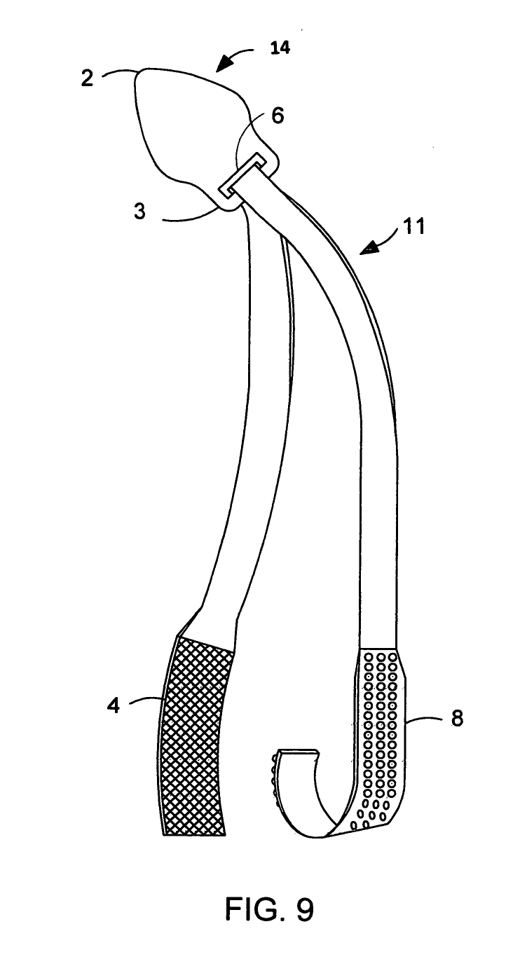

As we proceed to FIG. 9, there is shown a VLT 11 after it has been inserted through the aperture 6 of a bottom-slotted plectrum 14. A musician using this plectrum-tether combination would insert his playing hand in between the two suspended segments of the VLT 11 while holding the bottom-slotted plectrum 14 Preferably, the VLT 11 is loosely wrapped, in a comfortable fit, about the four fingers of the playing hand and then the VLT 11 is fastened by attaching the hook component 4 to the felt component 8 of the VLT 11.

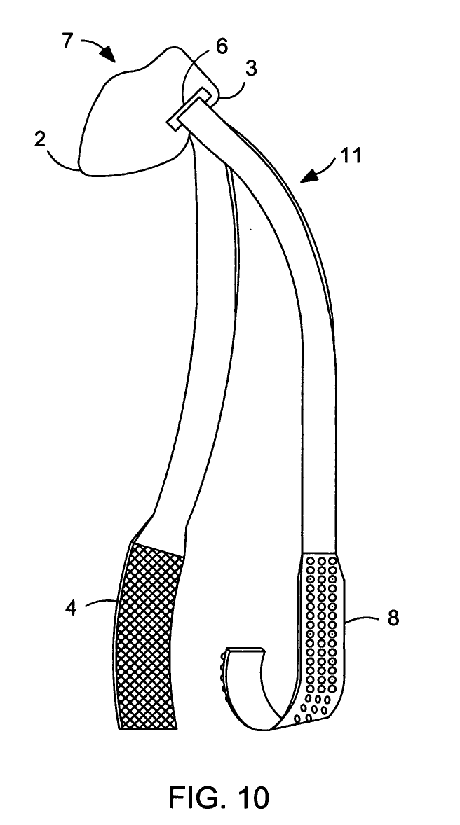

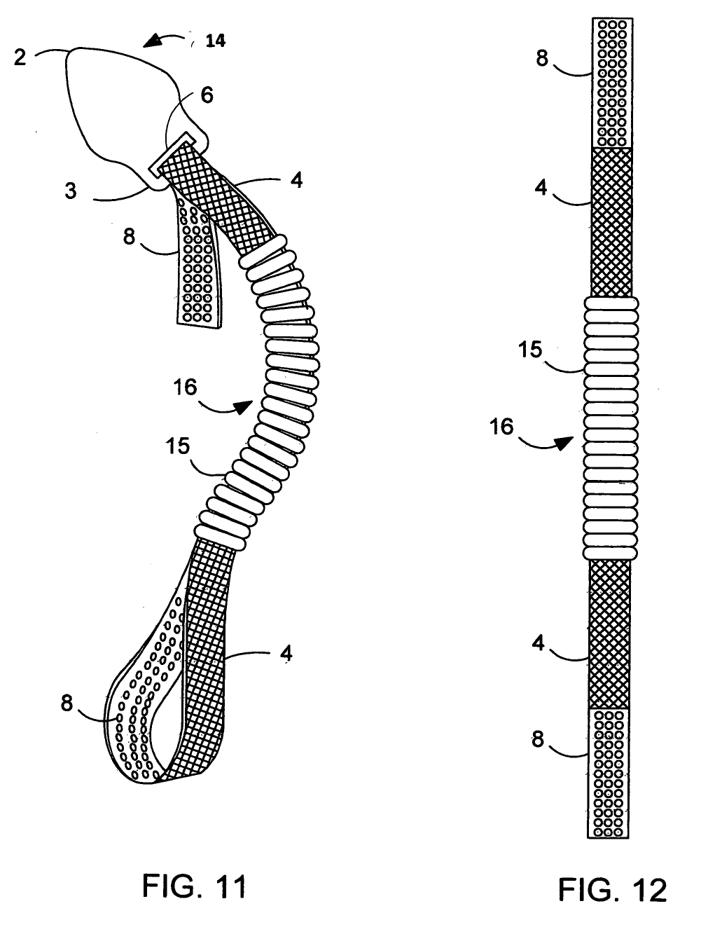

FIG. 10 reveals the orientation of the combination of an SLT 9 as attached to a side-slotted plectrum 7. FIG. 11 and FIG. 12 present differing views of an extendable-length tether (ELT) 16, which functions very similar to the SLT, with the additional option of increasing the vertical length of the ELT for an appropriate fit to the musician's playing hand.

For general consumer marketing, most plectrums or picks are fabricated of a relatively inexpensive, thin plastic which is designed to bend, but may also break if sufficient force is applied to the plectrum. The tension of the VLT 11 or the SLT 9, as either device is routinely pulled against the aperture 6 of either of the slotted plectrums 7, 14, may also place additional vulnerable stress points on the tab 3 and cause occasional breakage. In the event of breakage of any of the slotted plectrums 7, 14, the musician may choose to continue playing the remainder of the musical passage by holding the plectrum without the assistance of the tether. When time permits, the musician need only undo the fastening mechanism of the tether, insert one end of the tether into the aperture 6 of a spare slotted-plectrum 7, 14, and re-fasten.

It must be realized that the embodiments presented in this inventive concept are not dependent solely upon a hook-and-felt mechanism as the means of efficient or effective fastening of any of the disclosed tabbed plectrums to any grasping device, or as the means of re-attaching any grasping device to itself. Fastening means such as zippers, pins, suction devices, track-and-groove fasteners, miniature snaps, magnets, or other mechanisms may function as well, if not better. In other words, a variety of fastening means are readily capable of providing the functionality encompassed by this inventive concept and this variety of fastening means is fully envisioned as probable alternative embodiments of the concept. Furthermore, any grasping device may feature use of an expandable or flexible medium in conjunction with any of grasping devices.

What is claimed is:

1. A device suitable for playing a stringed musical instrument, comprising a plectrum of flat, planar structure formed from any of a variety of materials in the approximate shape of an isosceles triangle with gently rounded base angles, an elliptically-shaped planar picking point at its apex, with the base of said plectrum extended so as to form a tab, and further, having a grasping device attached to said tab by a fastening means integral to said tab.

2. A device as in claim 1, wherein said fastening means comprises a tab constructed with an integral hook component of a velcro-type fastening mechanism and, further, having a grasping device selected from the group consisting of an SLT, a VLT, or an ELT.

3. A device suitable for playing a stringed musical instrument, comprising a plectrum of flat, planar structure formed from any of a variety of materials in the approximate shape of an isosceles triangle with gently rounded base angles, an elliptically-shaped planar picking point at its apex, with the base of said plectrum extended so as to form a tab, said tab, having an aperture excised from said tab perpendicular to the base of said tab, further having a grasping device inserted through said aperture, said grasping device being attachable to itself.

4. A device as in claim 3, further comprising an attachable grasping device selected from the group consisting of an SLT, a VLT, a DFT, or an ELT.

5. A device suitable for playing a stringed musical instrument, comprising a plectrum of flat, planar structure formed from any of a variety of materials in the approximate shape of an isosceles triangle with gently rounded base angles, an elliptically-shaped planar picking point at its apex, with the base of said plectrum extended so as to form a tab, said tab having an aperture excised parallel to the base of said tab, further having a grasping device inserted through said aperture, said grasping device being attachable to itself.

6. A device as in claim 5, further comprising an attachable grasping device selected from the group consisting of an SLT, a VLT, a DFT, or an ELT.

7. A method for the ergonomic playing of a stringed musical instrument when using a pick or plectrum device, comprising the steps of:
a) utilizing a device as in claim 3;
b) inserting into the aperture of said plectrum a grasping device referred to as a Variably-Looped Tether (VLT);
c) grasping said plectrum between the thumb and the index finger of the strumming or playing hand;
d) fastening the free ends of said VLT to each other;
e) allowing the VLT to fit freely in a vertical orientation by rotating the wrist of the strumming hand into a playing position wherein the forearm is oriented approximately parallel to the strings of the musical instrument;
f) grasping the VLT lightly, with the remaining fingers of the strumming hand;
g) orienting the strumming hand such that, while loosely grasping the VLT, the outside edge of the thumbnail, the web of the thumb, the inside bone of the wrist, and the center of the elbow are oriented in a straight line, said line being referred to as the “forearm static vector;”
h) holding and/or resting the stringed instrument by shoulder strap or other means such that the forearm static vector is generally parallel to, and in the same direction as, the layout of the strings on the instrument;
i) rotating the wrist in a circular motion about the forearm static vector such as to cause the plectrum to strike the desired string(s) of the musical instrument while firmly holding the plectrum; and
j) maintaining a torque-like action of the forearm muscles of the strumming hand to power and control the rotation of the wrist about the forearm static vector, therefore causing the wrist to rotate and consequently control the plectrum's dynamics at any desired speed, intensity, frequency, and angle of rotation.

8. A device as in claim 1 wherein said fastening means comprises a fastening mechanism selected from the group consisting of snaps, magnets, adhesives, zippers, grooved slots, pins, or hooks.
